(19) United States
(12) Patent Application Publication
(10) Pub. No.: US 2012/0259038 A1
(43) Pub. Date: Oct. 11, 2012

(54) RUBBER COMPOSITION FOR CAP TREAD AND WINTER TIRE

(76) Inventor: Ryoji Kojima, Kobe-shi (JP)

(21) Appl. No.: 13/439,218

(22) Filed: Apr. 4, 2012

(30) Foreign Application Priority Data
Apr. 5, 2011 (JP) 2011-083846

(51) Int. Cl. C08L 9/00; C08K 5/47

(52) U.S. Cl. 523/156

(57) ABSTRACT

Provided are a rubber composition that makes it possible to improve heat resistance and particularly suppress changes in the properties (e.g. hardness) of the vulcanized rubber composition with long-term use (rubber hardening degradation) to suppress a reduction in performance on snow and ice to extend the life-span, without increase in the antioxidant amount, achieve good performance on snow and ice, wet-grip performance, and abrasion resistance, and reduce curing time and enhance cross-linking efficiency; and a winter tire including a cap tread produced from the composition. The rubber composition for a cap tread comprises a rubber component containing an isoprene-based rubber and butadiene rubber; silica; aromatic oil; a compound represented by formula (I) and/or formula (II); and a thiuram vulcanization accelerator, wherein the amount of silica is 15-80 parts by mass, and the amount of aromatic oil is 15-80 parts by mass, per 100 parts by mass of the rubber component.

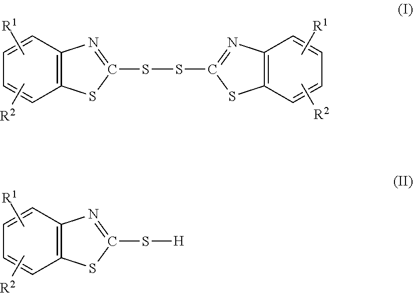

### TECHNICAL FIELD

The present invention relates to a rubber composition for a cap tread and a winter tire (studless tire) produced using the rubber composition.

### BACKGROUND ART

Vehicles have been equipped with spike tires or tires with chains when driving snow- and ice-covered roads. This, however, causes environmental problems such as powder dust pollution, and therefore winter tires (studless tires) have been developed as the replacement for the spike tires and the tires with chains for driving snow- and ice-covered roads. The winter tires have been improved in their materials and designs to drive the snow-covered roads having rougher surfaces compared to the surfaces of usual roads. For example, there has been developed a rubber composition that contains diene rubber having excellent low-temperature properties and contains a large amount of a softener in order to enhance a softening effect.

As the softener, mineral oil (paraffinic oil) with a large effect of improving low-temperature properties (performance on snow and ice (braking performance on snow and ice)) is often used. However, when mineral oil is used, sufficient abrasion resistance is disadvantageously not achieved.

The use of aromatic oil in place of mineral oil in order to solve that problem causes another problem of deterioration of low-temperature properties although good abrasion resistance is achieved. In order to solve this problem, silica is used in combination with aromatic oil, which improves low-temperature properties without impairing good abrasion resistance. However, this cannot sufficiently improve abrasion resistance and low-temperature properties (performance on snow and ice) together.

Meanwhile, antioxidants have been widely used for conventional rubber compositions for tires and the like in order to improve the heat resistance of the rubber compositions. Examples of antioxidants for general purposes include amine antioxidants such as N-(1,3-dimethylbutyl)-N′-phenyl-p-phenylenediamine (6PPD) and N-phenyl-N′-isopropyl-p-phenylenediamine (IPPD).

As the hardness of the winter tire increases through degradation over time (hardening degradation), the performance on snow and ice may greatly decrease. Conventionally, in order to solve this problem, the amount of an antioxidant has been increased or the kind of a softener has been selected. However, the method of increasing the amount of an antioxidant causes problems such as that the tire surface turns brown due to blooming of the antioxidant on the surface, which leads to poor appearance of the tire. In addition, the method of selecting the kind of a softener causes reduction in the performance on snow and ice itself depending on the particular softener, and therefore cannot sufficiently improve the performance on snow and ice and the resistance to hardening degradation together.

Accordingly, there is a need to provide a rubber composition that improves in heat resistance and has an extended life-span, without increase in the antioxidant amount, and also achieves both good abrasion resistance and good performance on snow and ice.

Patent Document 1 discloses a rubber composition in which N-(1-methylheptyl)-N′-phenyl-p-phenylenediamine as an antioxidant and wax are added to diene rubber. However, it still has room for improvement in sufficiently improving both abrasion resistance and the performance on snow and ice while enhancing heat resistance.
Patent Document 1: JP H10-324779 A

### SUMMARY OF THE INVENTION

The present invention aims to solve the above problems and to provide a rubber composition that makes it possible to improve heat resistance and particularly suppress changes in the properties (e.g. hardness) of the vulcanized rubber composition with long-term use (rubber hardening degradation) to suppress a reduction in performance on snow and ice in order to extend the life-span, without increase in the antioxidant amount, achieve good performance on snow and ice, wet grip performance, and abrasion resistance, and reduce curing time and enhance cross-linking efficiency; and a winter tire including a cap tread produced from the rubber composition.

The present inventor has found that the combined use of a large amount of aromatic oil and a large amount of silica enables sufficient improvement in both the abrasion resistance and the performance on snow and ice. However, such a large amount of oil causes a new problem that the hardness significantly increases through degradation over time (hardening degradation), resulting in a significant reduction in performance on snow and ice over time.

Then, as a result of further investigations, the present inventor has found that when the rubber composition includes a rubber component containing an isoprene-based rubber and a butadiene rubber and a compound represented by formula (I) and/or formula (II) in addition to a large amount of aromatic oil and a large amount of silica, good abrasion resistance and good performance on snow and ice can be achieved together, and at the same time, the heat resistance can be improved, and in particular, rubber hardening degradation can be suppressed, whereby the new problem can be solved. However, this method causes other problems of increase in curing time and reduction in cross-linking efficiency. Then, as a result of earnest investigations, the present inventor has found that the addition of a thiuram vulcanization accelerator to the above components can achieve both good abrasion resistance and good performance on snow and ice, improve heat resistance (particularly the resistance to rubber hardening degradation), and at the same time, reduce curing time and enhance cross-linking efficiency, so that the above other problems can also be solved. Thus, the present invention has been completed.

Specifically, the present invention relates to a rubber composition for a cap tread, comprising: a rubber component containing an isoprene-based rubber and a butadiene rubber; silica; aromatic oil; a compound represented by the following formula (I) and/or formula (II); and a thiuram vulcanization accelerator, wherein the amount of the silica is 15 to 80 parts by mass, and the amount of the aromatic oil is 15 to 80 parts by mass, per 100 parts by mass of the rubber component.

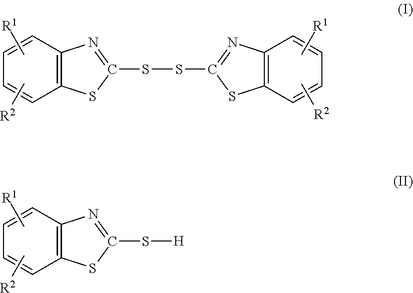

In formulae (I) and (II), R¹ and R² may be the same as or different from each other and each represent a hydrogen atom, an alkyl group, an aryl group, or an aralkyl group, provided that the case where R¹ and R² are simultaneously hydrogen atoms is excluded.

Preferably, in the rubber composition, the amount of the silica is 40 to 80 parts by mass, and the amount of the aromatic oil is 35 to 80 parts by mass, per 100 parts by mass of the rubber component.

In the rubber composition, the amount of the thiuram vulcanization accelerator is preferably 0.1 to 1.2 parts by mass per 100 parts by mass of the rubber component.

The isoprene-based rubber is preferably at least one selected from the group consisting of an isoprene rubber, a natural rubber, and a modified natural rubber.

The compound is preferably represented by the following formula (III).

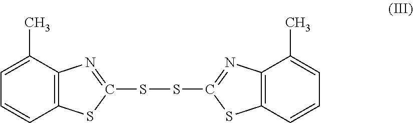

In the rubber composition, the total amount of the isoprene-based rubber and the butadiene rubber in 100% by mass of the rubber component is preferably 30 to 100% by mass.

In the rubber composition, the amount of the silica in 100% by mass of a total of the silica and carbon black is preferably 50% by mass or more.

The present invention also relates to a winter tire, comprising a cap tread produced from the rubber composition.

The rubber composition of the present invention comprises a rubber component containing an isoprene-based rubber and a butadiene rubber, a predetermined amount of silica, a predetermined amount of aromatic oil, a compound represented by formula (I) and/or formula (II), and a thiuram vulcanization accelerator. Accordingly, the rubber composition achieves good performance on snow and ice when it is in an initial state, achieves good wet grip performance and good abrasion resistance, and also makes it possible to improve heat resistance and particularly suppress changes in the properties (e.g. hardness) of the vulcanized rubber composition with long-term use (especially, rubber hardening degradation) to suppress a reduction in performance on snow and ice caused over time. Further, it is possible to reduce curing time and enhance cross-linking efficiency.

Such resistance to hardening degradation is far greater than those of SBR-containing compositions such as those containing SBR and carbon black and those of mineral oil-containing compositions.

In addition, since the present invention improves cross-linking efficiency, the performances in terms of rolling resistance, abrasion resistance, and wet grip performance can be improved. Accordingly, it is possible to maintain good performance on snow and ice, wet grip performance, and abrasion resistance and extend the life-span of the rubber composition, without increase in the amount of an antioxidant such as 6PPD, and also to reduce curing time and enhance cross-linking efficiency. Therefore, the rubber composition of the present invention is suitably applicable to a cap tread of a winter tire.

### BEST MODE FOR CARRYING OUT THE INVENTION

The rubber composition of the present invention includes a rubber component containing an isoprene-based rubber and a butadiene rubber, a predetermined amount of silica, a predetermined amount of aromatic oil, a compound represented by formula (I) and/or formula (II), and a thiuram vulcanization accelerator.

If the rubber composition includes a predetermined amount of silica and a predetermined amount of aromatic oil, the abrasion resistance and the performance on snow and ice can be improved together at high levels. In addition, if the rubber composition includes a predetermined amount of silica, the wet grip performance, a disadvantage of a winter tire, can also be improved.

If the rubber composition further includes a rubber component containing an isoprene-based rubber and a butadiene rubber, and a compound represented by formula (I) and/or formula (II), the abrasion resistance and the performance on snow and ice can be improved together at high levels, and at the same time, the heat resistance, which should be reduced by using the predetermined amount of aromatic oil, can be improved, and the changes in properties (e.g. hardness) of the vulcanized rubber composition with long-term use, particularly rubber hardening degradation, can be suppressed.

If the rubber composition further includes a thiuram vulcanization accelerator in addition to the above components, both good abrasion resistance and good performance on snow and ice can be achieved, and the heat resistance (especially the resistance to rubber hardening degradation) can be improved, and at the same time, the aforementioned other problems of increase in curing time and reduction in cross-linking efficiency, which should be caused by using the above components, can be solved (this is, the cross-linking efficiency can be enhanced and the curing time can be reduced). Further, the enhancement of cross-linking efficiency by the thiuram vulcanization accelerator leads to a reduction in the amount of sulfur that is not involved in effective cross-linking which links rubber molecules, in the rubber composition. Accordingly, it is possible to prevent problems such as hardening degradation caused by changes of such useless sulfur with aging. In addition, the enhanced cross-linking efficiency leads to improvements in terms of rolling resistance, abrasion resistance, and wet grip performance.

The “rubber hardening degradation” used herein means a degradation phenomenon in which after heat has been applied to a vulcanized rubber composition in the presence of oxygen as a degradation factor, the vulcanized rubber composition becomes harder than that in an initial state. In the present invention, such degradation can be effectively suppressed. Such resistance to hardening degradation is completely different from so-called thermal fatigue resistance (prevention of blow-out and chunk-out) and heat sag resistance, and is specifically shown in the case that the rubber composition includes three components: an isoprene-based rubber, silica, and a compound represented by formula (I) and/or formula (II).

Further, in the case where the rubber composition includes these three components, the effect of improving heat resistance (particularly the resistance to hardening degradation) is synergistically exerted. This rubber composition shows a markedly great resistance to hardening degradation compared with, for example, a rubber composition including a styrene butadiene rubber, silica, and a compound represented by formula (I) and/or formula (II).

In addition, in the case where the rubber composition contains aromatic oil with these three components, a markedly great resistance to hardening degradation is shown compared with a rubber composition including mineral oil with these three components.

In the present invention, the rubber component contains an isoprene-based rubber. Although a rubber with an isoprene skeleton is used in the present invention, the heat resistance (particularly the resistance to hardening degradation) is improved. Examples of the isoprene-based rubber include isoprene rubber (IR), natural rubber (NR), and modified natural rubber. Examples of the NR include deproteinized natural rubber (DPNR) and highly purified natural rubber (HPNR), and examples of the modified natural rubber include epoxidized natural rubber (ENR), hydrogenated natural rubber (HNR), and grafted natural rubber. Specific examples of the NR include ones generally used in the tire industry, such as SIR20, RSS#3 and TSR20. Preferable among these are NR and IR because of their low cost.

The amount of the isoprene-based rubber in 100% by mass of the rubber component is preferably 20% by mass or more, and more preferably 40% by mass or more. If the amount is less than 20% by mass, sufficient resistance to hardening degradation may not be achieved. The amount of the isoprene-based rubber in 100% by mass of the rubber component is preferably 80% by mass or less, and more preferably 70% by mass or less. If the amount exceeds 80% by mass, low-temperature properties (performance on snow and ice) required for a winter tire may not be secured.

In the present invention, the rubber component contains a butadiene rubber (BR) with the isoprene-based rubber. If the rubber composition contains BR, good low-temperature properties (performance on snow and ice) can be achieved.

The BR is not particularly limited. Examples thereof include BRs with high cis content such as BR1220 and BR1250H (each produced by ZEON Corporation), and BR130B and BR150B (each produced by Ube Industries, Ltd.); and syndiotactic polybutadiene crystal-containing BRs such as VCR412 and VCR617 (each produced by Ube Industries, Ltd.). BRs with a cis content of 90% by mass or more are preferable among these because they enable maintenance of low-temperature properties (performance on snow and ice).

The amount of the BR in 100% by mass of the rubber component is preferably 10% by mass or more, and more preferably 20% by mass or more. If the amount is less than 10% by mass, low-temperature properties (performance on snow and ice) required for a winter tire may not be secured. The amount of the BR in 100% by mass of the rubber component is preferably 80% by mass or less, and more preferably 60% by mass or less. If the amount exceeds 80% by mass, the amount of the isoprene-based rubber is reduced, and thus sufficient resistance to hardening degradation may not be achieved.

The total amount of the isoprene-based rubber and the butadiene rubber in 100% by mass of the rubber component is preferably 30% by mass or more, more preferably 60% by mass or more, further preferably 80% by mass or more, and particularly preferably 100% by mass. The larger the total amount of the isoprene-based rubber and the butadiene rubber is, the better the resistance to hardening degradation and the low-temperature properties (performance on ice and snow) are.

Examples of rubbers other than the isoprene-based rubber and BR which may be contained in the rubber component include styrene butadiene rubber (SBR), styrene isoprene butadiene rubber (SIBR), ethylene propylene diene rubber (EPDM), chloroprene rubber (CR), and acrylonitrile butadiene rubber (NBR). These rubbers may be used alone, or two or more kinds thereof may be used in combination.

The rubber composition of the present invention contains a predetermined amount of silica. This improves heat resistance (particularly the resistance to hardening degradation), and also provides good wet grip performance, good abrasion resistance, and good performance on snow and ice required for a winter tire. The silica is not particularly limited. Examples thereof include dry silica (silicic anhydride) and wet silica (hydrous silicic acid). Wet silica is preferable because it has a larger amount of silanol groups. One kind of silica may be used alone, or two or more kinds thereof may be used in combination.

The nitrogen adsorption specific surface area (N₂SA) of the silica is preferably 50 m²/g or more, more preferably 80 m²/g or more, and further preferably 100 m²/g or more. If the N₂SA is less than 50 m²/g, rubber reinforcement tends to decrease. The N₂SA of the silica is preferably 300 m²/g or less, more preferably 250 m²/g or less, and further preferably 200 m²/g or less. If the N₂SA is more than 300 m²/g, the viscosity of the rubber composition tends to increase and the processability tends to deteriorate.

The nitrogen adsorption specific surface area of silica is determined by the BET method in accordance with ASTM D3037-81.

The amount of the silica is 15 parts by mass or more, preferably 40 parts by mass or more, and more preferably 50 parts by mass or more, per 100 parts by mass of the rubber component. If the amount is less than 15 parts by mass, the resistance to hardening degradation, the wet grip performance, the abrasion resistance, and the performance on snow and ice cannot be sufficiently achieved. In addition, if the amount of the silica is 40 parts by mass or more, particularly good wet grip performance, abrasion resistance, and performance on snow and ice can be achieved. The amount of the silica is 80 parts by mass or less, and preferably 70 parts by mass or less, per 100 parts by mass of the rubber component. If the amount is more than 80 parts by mass, the processability and workability deteriorate. In addition, such increase in the amount of filler results in deterioration of low-temperature properties (performance on snow and ice).

The rubber composition of the present invention preferably contains a silane coupling agent together with silica.

Any silane coupling agents conventionally used with silica in the rubber industry may be used. Examples thereof include sulfide-type silane coupling agents such as bis(3-triethoxysilylpropyl)tetrasulfide, bis(3-triethoxysilylpropyl)disulfide, bis(2-triethoxysilylethyl)disulfide, bis(4-triethoxysilylbutyl)disulfide, bis(3-trimethoxysilylpropyl)disulfide, bis(2-trimethoxysilylethyl)disulfide, bis(4-trimethoxysilylbutyl)disulfide, 3-trimethoxysilylpropylbenzothiazolyl tetrasulfide, and 3-triethoxysilylpropylbenzothiazole tetrasulfide. Other examples thereof include mercapto-type, vinyl-type, glycidoxy-type, nitro-type, and chloro-type silane coupling agents. Preferable among these are bis(3-triethoxysilylpropyl)tetrasulfide and bis(3-triethoxysilylpropyl)disulfide in terms of the reinforcing effect of the silane coupling agent and processability. Each of these silane coupling agents may be used alone or two or more of these may be used in combination.

The amount of the silane coupling agent is preferably 1 part by mass or more, and more preferably 2 parts by mass or more, per 100 parts by mass of the silica. If the amount is less than 1 part by mass, the tensile strength and abrasion resistance tend to decrease significantly. The amount of the silane coupling agent is preferably 15 parts by mass or less, and more preferably 10 parts by mass or less, per 100 parts by mass of the silica. If the amount is more than 15 parts by mass, the effects caused by adding the silane coupling agent, such as increase in tensile strength and abrasion resistance and decrease in rolling resistance, tend not to be exerted enough to be commensurate with the added amount.

In the present invention, a compound represented by the following formula (I) and/or formula (II) and a thiuram vulcanization accelerator are used in combination as vulcanization accelerators. A rubber composition that includes a rubber component containing an isoprene-based rubber and BR may be inferior in heat resistance and aging resistance, and may undergo greater changes in vulcanized properties (e.g. hardness) with long-term use (especially hardening degradation); but the changes in properties can be suppressed by the use of the compound represented by formula (I) and/or formula (II). On the other hand, however, the use of the compound causes increase in curing time and reduction in cross-linking efficiency. Then if the rubber composition further contains a guanidine accelerator, the reduction in cross-linking efficiency is somewhat suppressed, but this improvement is not sufficient yet. In addition, the scorch time decreases, and therefore rubber scorch may occur. In contrast, the rubber composition of the present invention, which contains a specific vulcanization accelerator, a thiuram vulcanization accelerator, with the compound, has a sufficiently improved cross-linking efficiency with appropriate scorch resistance. Accordingly, with respect to the unvulcanized rubber composition, the curing time can be reduced and the cross-linking efficiency can be further improved while favorable scorch resistance is maintained. In addition, the performance of the vulcanized rubber composition can be improved in terms of rolling resistance, abrasion resistance, and wet grip performance.

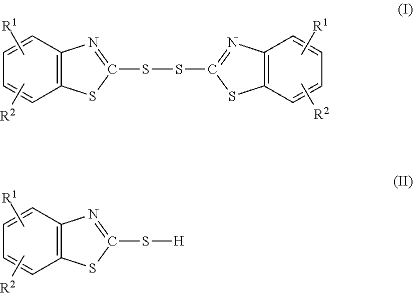

In formulae (I) and (II), R¹ and R² may be the same as or different from each other, and each represent a hydrogen atom, an alkyl group, an aryl group, or an aralkyl group, provided that the case where R¹ and R² are simultaneously hydrogen atoms is excluded (that is, compounds in which both R¹ and R² bonded to the same ring are hydrogen atoms are excluded.).

For R¹ and R², preferable are C₁-C₁₀ alkyl groups, C₆-C₁₀ aryl groups, and C₇-C₁₀ aralkyl groups. Examples of the alkyl group include a methyl group, an ethyl group, an n-propyl group, an isopropyl group, an n-butyl group, an iso-butyl group, a sec-butyl group, a tert-butyl group, a pentyl group, a hexyl group, a heptyl group, a 2-ethylhexyl group, an octyl group, a nonyl group, and a decyl group. Examples of the aryl group include a phenyl group, a tolyl group, a xylyl group, a biphenyl group, a naphthyl group, an anthryl group, and a phenanthryl group. Examples of the aralkyl group include a benzyl group and a phenethyl group. The hydrocarbon group for R¹ or R² may be a straight, branched, or cyclic group. Preferable among alkyl groups, aryl groups, and aralkyl groups are alkyl groups. The number of carbons of the alkyl group is preferably 1 to 4 and more preferably 1 to 2. Preferably, R¹ is an alkyl group and R² is a hydrogen atom. In this case, the resistance to hardening degradation is favorably achieved.

Specific examples of the compound represented by formula (I) include: bis(4-methylbenzothiazolyl-2)-disulfide, bis(4-ethylbenzothiazolyl-2)-disulfide, bis(5-methylbenzothiazolyl-2)-disulfide, bis(5-ethylbenzothiazolyl-2)-disulfide, bis(6-methylbenzothiazolyl-2)-disulfide, bis(6-ethylbenzothiazolyl-2)-disulfide, bis(4,5-dimethylbenzothiazolyl-2)-disulfide, bis(4,5-diethylbenzothiazolyl-2)-disulfide, bis(4-phenylbenzothiazolyl-2)-disulfide, bis(5-phenylbenzothiazolyl-2)-disulfide, and bis(6-phenylbenzothiazolyl-2)-disulfide. Specific examples of the compound represented by formula (II) include: 2-mercapto-4-methylbenzothiazole, 2-mercapto-4-ethylbenzothiazole, 2-mercapto-5-methylbenzothiazole, 2-mercapto-5-ethylbenzothiazole, 2-mercapto-6-methylbenzothiazole, 2-mercapto-6-ethylbenzothiazole, 2-mercapto-4,5-dimethylbenzothiazole, 2-mercapto-4,5-diethylbenzothiazole, 2-mercapto-4-phenylbenzothiazole, 2-mercapto-5-phenylbenzothiazole, and 2-mercapto-6-phenylbenzothiazole. Preferable among these are bis(4-methylbenzothiazolyl-2)-disulfide, bis(5-methylbenzothiazolyl-2)-disulfide, 2-mercapto-4-methylbenzothiazole, and 2-mercapto-5-methylbenzothiazole. The compound represented by formula (I) is more suitably used than the compound represented by formula (II). A compound represented by the following formula (III) (4m-MBTS) is particularly suitably used among the above-mentioned compounds. When using the above-mentioned compounds, the resistance to hardening degradation is favorably achieved.

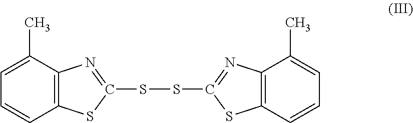

One kind of the compound represented by formula (I) and/or formula (II) may be used alone, or two or more kinds thereof may be used in combination. As a commercial product of the compound, a product produced by NOCIL Ltd., for example, may be used.

The total amount of the compound represented by formula (I) and/or formula (II) is preferably 0.1 parts by mass or more, more preferably 0.2 parts by mass or more, and further preferably 0.4 parts by mass or more, per 100 parts by mass of the rubber component. If the total amount is less than 0.1 parts by mass, sufficient resistance to hardening degradation may not be achieved. The total amount is preferably 5.0 parts by mass or less, more preferably 3.0 parts by mass or less, and further preferably 2.0 parts by mass or less, per 100 parts by mass of the rubber component. If the total amount exceeds 5.0 parts by mass, it may be difficult to maintain a suitable crosslink density and cross-linking structure.

Examples of the thiuram vulcanization accelerator include: tetramethylthiuram disulfide (TMTD), tetraethylthiuram disulfide, tetramethylthiuram monosulfide (TMTM), dipentamethylenethiuram disulfide, dipentamethylenethiuram monosulfide, dipentamethylenethiuram tetrasulfide, dipentamethylenethiuram hexasulfide, tetrabutylthiuram disulfide, pentamethylenethiuram tetrasulfide, and tetrakis(2-ethylhexyl)thiuram disulfide. Preferable among these are TMTM, tetraethylthiuram disulfide, and tetrabutylthiuram disulfide in terms of enhancing cross-linking efficiency, maintaining appropriate scorch resistance, reducing curing time, and having toxicity lower than those of compounds including TMTD.

The amount of the thiuram vulcanization accelerator is preferably 0.1 parts by mass or more, more preferably 0.2 parts by mass or more, and further preferably 0.6 parts by mass or more, per 100 parts by mass of the rubber component. If the amount is less than 0.1 parts by mass, the curing time may not be sufficiently reduced, and the cross-linking efficiency may not be sufficiently improved. The amount of the thiuram vulcanization accelerator is preferably 1.2 parts by mass or less, and more preferably 1.1 parts by mass or less, per 100 parts by mass of the rubber component. If the amount exceeds 1.2 parts by mass, the thiuram vulcanization accelerator may bloom, the scorch time may decrease, and the cost may increase unnecessarily.

In addition, the performance on snow and ice, wet grip performance, and abrasion resistance may deteriorate.

The rubber composition of the present invention may contain another vulcanization accelerator in addition to the compound represented by formula (I) and/or formula (II) and the thiuram vulcanization accelerator. In this case as well, the resistance to hardening degradation is favorably achieved.

Examples of other vulcanization accelerators include N-tert-butyl-2-benzothiazolylsulfenamide (TBBS), N-cyclohexyl-2-benzothiazolylsulfenamide (CBS), N,N′-dicyclohexyl-2-benzothiazolylsulfenamide (DZ), mercaptobenzothiazole (MBT), dibenzothiazolyl disulfide (MBTS), and diphenylguanidine (DPG). For example, 0.1 to 2.0 parts by mass of DPG may be added with respect to 100 parts by mass of the rubber component.

In the present invention, a predetermined amount of aromatic oil is used. This enables an improvement in both the abrasion resistance and the performance on snow and ice at high levels. Further, its use in combination with the predetermined amount of silica enables a further improvement in both the abrasion resistance and the performance on snow and ice at higher levels. In addition, compared with the case of using mineral oil, the effect of improving heat resistance (particularly the resistance to hardening degradation) is greater, the wet grip performance and abrasion resistance are better, and the curing time is shorter.

Usually, if the oil amount is increased, the hardness greatly increases through degradation over time (hardening degradation), leading to a reduction in performance on snow and ice with time. In contrast, since the present invention employs an isoprene-based rubber, silica, and a compound represented by the above formula (I) and/or formula (II), hardening degradation is favorably suppressed even with the predetermined oil amount. Therefore, good abrasion resistance and good performance on snow and ice can be achieved, and the reduction in performance on snow and ice with time can be suppressed.

The aromatic oil is not particularly limited, and examples thereof include AC-12, AC-460, AH-16, AH-24, and AH-58 produced by Idemitsu Kosan Co., Ltd., and Process NC300S produced by Japan Energy Corporation. One kind of aromatic oil may be used alone, or two or more kinds thereof may be used in combination.

The amount of the aromatic oil is 15 parts by mass or more, preferably 35 parts by mass or more, and more preferably 50 parts by mass or more, per 100 parts by mass of the rubber component. If the amount is less than 15 parts by mass, a sufficient softening effect cannot be exerted, and thus sufficient performance on snow and ice may not be achieved. If the amount of the aromatic oil is 35 parts by mass or more, particularly good wet grip performance, abrasion resistance, and performance on snow and ice can be obtained. The amount of the aromatic oil is 80 parts by mass or less, and preferably 70 parts by mass or less, per 100 parts by mass of the rubber component. If the amount exceeds 80 parts by mass, the processability greatly deteriorates, the abrasion resistance decreases, and the resistance to hardening degradation is lowered.

In addition to the above ingredients, the rubber composition of the present invention may optionally contain, as appropriate, compounding ingredients conventionally used in the rubber industry. Examples of the compounding ingredients include fillers such as carbon black, stearic acid, zinc oxide, antioxidants, waxes, and vulcanizing agents such as sulfur and sulfur compounds.

Examples of usable carbon black include, but not limited to, GPF, FEF, HAF, ISAF, and SAF. The addition of carbon black improves reinforcement.

The nitrogen adsorption specific surface area (N₂SA) of the carbon black is preferably 70 m²/g or more, and more preferably 90 m²/g or more. If the N₂SA is less than 70 m²/g, rubber reinforcement tends to decrease. The N₂SA of the carbon black is preferably 300 m²/g or less, more preferably 250 m²/g or less, and further preferably 150 m²/g or less. If the N₂SA is more than 300 m²/g, the processability of the rubber composition tends to deteriorate.

The nitrogen adsorption specific surface area of carbon black is determined by the A method in accordance with JIS K6217.

If the rubber composition contains carbon black with the silica, the total amount of the silica and carbon black is preferably 40 parts by mass or more, and more preferably 50 parts by mass or more, per 100 parts by mass of the rubber component. If the total amount is less than 40 parts by mass, the resistance to hardening degradation may not be favorably achieved. The total amount is preferably 100 parts by mass or less, and more preferably 80 parts by mass or less, per 100 parts by mass of the rubber component. If the total amount exceeds 100 parts by mass, the dispersibility of filler may deteriorate.

The amount of the silica in 100% by mass of a total of the silica and carbon black is preferably 50% by mass or more, more preferably 70% by mass or more, and further preferably 85% by mass or more because the resistance to hardening degradation, the wet grip performance, the abrasion resistance, and the performance on snow and ice can be favorably achieved.

In the present invention, an amine antioxidant may be suitably used as an antioxidant because of its excellent breaking properties. In this case, it is possible to improve heat resistance (particularly the resistance to hardening degradation) without increase in the amount of the antioxidant. Examples of the amine antioxidant include amine derivatives such as diphenylamine derivatives and p-phenylenediamine derivatives. Examples of the diphenylamine derivatives include p-(p-toluenesulfonylamide)-diphenylamine, and octylated diphenylamine. Examples of the p-phenylenediamine derivatives include N-(1,3-dimethylbutyl)-N′-phenyl-p-phenylenediamine (6PPD), N-phenyl-N′-isopropyl-p-phenylenediamine (IPPD), and N,N′-di-2-naphthyl-p-phenylenediamine.

The amount of the amine antioxidant is preferably 1 part by mass or more, and more preferably 1.5 parts by mass or more, per 100 parts by mass of the rubber component. If the amount is less than 1 part by mass, the breaking properties may not be improved. The amount is preferably 6 parts by mass or less, and more preferably 4 parts by mass or less, per 100 parts by mass of the rubber component. If the amount exceeds 6 parts by mass, bloom may form on the surface.

The rubber composition of the present invention can be produced by a usual method. More specifically, the rubber composition may be produced by mixing the aforementioned ingredients with, for example, a Banbury mixer, a kneader or an open roll mill, and then vulcanizing the resultant mixture.

The rubber composition of the present invention is used for a cap tread of a winter tire. The cap tread is an outer surface layer of a tread having a multi-layer structure. The tread having a two-layer structure is composed of an outer surface layer (cap tread) and an inner surface layer (base tread).

The tread having a multi-layer structure may be produced by laminating rubber composition sheets into a predetermined shape, or by introducing a rubber composition into two or more extruders to form a sheet including two or more layers at the head exit of the extruders.

The winter tire of the present invention can be produced by a usual method using the rubber composition. More specifically, an unvalcanized rubber composition is extruded and processed into the shape of a cap tread, and then molded on a tire building machine by a usual method, and assembled with other tire components to form an unvulcanized tire. This unvulcanized tire is heated and pressurized in a vulcanizer to produce a winter tire.

The winter tire of the present invention is suitably used for passenger vehicles, trucks, and buses.

### EXAMPLES

The present invention is more specifically described based on examples, and the present invention is not limited to the examples.

In the following, the chemical agents used in

Examples and Comparative Examples are listed.

NR: RSS#3

BR: BR150B produced by Ube Industries, Ltd. (cis content: 97% by mass, ML₁₊₄ (100° C.): 40, viscosity of a 5% solution in toluene at 25° C.: 48 cps, Mw/Mn: 3.3)

Carbon black: N220 produced by Cabot Japan K.K. (N2SA: 111 m²/g)

Silica: Ultrasil VN3 produced by Evonik Degussa (N2SA: 175 m²/g)

Silane coupling agent: Si266 (bis(3-triethoxysilylpropyl)disulfide) produced by Evonik Degussa

Mineral oil: PS-32 produced by Idemitsu Kosan Co., Ltd.

Aromatic oil: Process NC300S produced by Japan Energy Corporation

Stearic acid: Kiri produced by NOF Corporation

Zinc oxide: Zinc oxide #2 produced by Mitsui Mining & Smelting Co., Ltd.

Antioxidant: NOCRAC 6C(N-(1,3-dimethylbutyl)-N′-phenyl-p-phenylenediamine) produced by Ouchi Shinko Chemical Industrial Co., Ltd.

Wax: OZOACE wax produced by Nippon Seiro Co., Ltd.

Sulfur: Sulfur powder produced by Tsurumi Chemical Industry Co., Ltd.

Vulcanization accelerator 4m-MBTS: bis(4-methylbenzothiazolyl-2)-disulfide (compound represented by formula (III)) produced by NOCIL Ltd.

Vulcanization accelerator TMTM: NOCCELER TS (tetramethylthiuram monosulfide) produced by Ouchi Shinko Chemical Industrial Co., Ltd.

Vulcanization accelerator NS: NOCCELER NS(N-tert-butyl-2-benzothiazolylsulfenamide) produced by Ouchi Shinko Chemical Industrial Co., Ltd.

Vulcanization accelerator DPG: NOCCELER D (diphenylguanidine) produced by Ouchi Shinko Chemical Industrial Co., Ltd.

### Examples 1 to 3 and Comparative Examples 1 to 7

According to the formulations shown in Table 1, materials other than the sulfur and vulcanization accelerators were kneaded with a 1.7-L Banbury mixer at 150° C. for 5 minutes to give a kneaded mixture. Thereafter, the sulfur and vulcanization accelerators were kneaded into the kneaded mixture with an open roll mill at 80° C. for 3 minutes, whereby an unvulcanized rubber composition was produced. A portion of the produced unvulcanized rubber composition was press-vulcanized with a mold having a thickness of 0.5 mm at 170° C. for 15 minutes, so that a vulcanized rubber composition was produced.

Another portion of each unvulcanized rubber composition was molded into the shape of a cap tread, assembled with other tire components, and vulcanized at 170° C. for 15 minutes to produce a test winter tire (tire size: 195/65R15).

### (Degradation Conditions)

The thus-produced vulcanized rubber compositions and test winter tires were thermally degraded in a 100° C. oven for 180 hours. The resultant compositions and tires were used as degraded samples (thermally-degraded vulcanized rubber compositions and thermally-degraded test winter tires).

The obtained unvulcanized rubber compositions, vulcanized rubber compositions, test winter tires, thermally-degraded vulcanized rubber compositions, and thermally-degraded test winter tires were evaluated in the following ways. Table 1 shows the results.

### <Vulcanization Test>

The obtained unvulcanized rubber composition was subjected to a vulcanization test at a measuring temperature of 170° C. with an oscillating curemeter (curelastometer produced by JSR) in accordance with JIS K6300 and then a curing rate curve plotting time versus torque was obtained.

The minimum torque in the curing rate curve was referred to as ML, the maximum thereof as MH, and the difference (MH-ML) as a torque rise (ME). The torque rise value of Comparative Example 1 was regarded as 100, and the result of each example was expressed as an index. A larger torque rise value indicates a higher and better cross-linking efficiency.

In addition, the time T₉₅ (minutes) (95% torque rise point) was read off at which the torque reached ML+0.95ME which indicates an optimum curing time. The time T₉₅ of Comparative Example 1 was regarded as 100, and the result of each example was expressed as an index. A larger curing time T₉₅ indicates a longer curing time and lower productivity.

### <Hardness (at −10° C.)>

The hardness at −10° C. of the vulcanized rubber composition and the thermally-degraded vulcanized rubber composition was determined with a type A durometer in accordance with JIS K6253 “Rubber, vulcanized or thermoplastic—Determination of hardness.”

### (Tg (Glass Transition Temperature))

The value for the peak tan δ of each vulcanized rubber composition was measured by a viscoelastic spectrometer VES (produced by Iwamoto Seisakusyo Co., Ltd.) under conditions of a temperature of −100 to 100° C. and a dynamic strain of 0.5%, and the measured value was obtained as Tg.

### <Performance on Snow and Ice>

A set of test winter tires (fresh ones) (tire size: 195/65R15) and a set of thermally-degraded test winter tires (tire size: 195/65R15) produced were each mounted on a FR car (2000 cc) made in Japan as a test vehicle. The brake stopping distance was measured which was a distance required for the car to stop on snow and ice under the following conditions after the brakes that lock up were applied at 30 km/h. The brake stopping distance of the test winter tire of Comparative Example 1 was regarded as 100, and the result of each example was expressed as an index of braking performance on snow and ice by the following equation. A larger index of braking performance on snow and ice indicates better braking performance on snow and ice (performance on snow and ice).

It is noted that prior to the test, a 100-km break-in driving was performed for break-in of the surface of the test tires.

| | ON ICE | ON SNOW |
|---|---|---|
| Test location | Test course in | Test course in |
| | Nayoro, Hokkaido | Nayoro, Hokkaido |
| Temperature | −1° C. to −6° C. | −2° C. to −10° C. |

(Index of braking performance on snow and ice)=(brake stopping distance in Comparative Example 1)/(brake stopping distance in each example)×100

### <Wet Grip Performance>

A set of test winter tires (fresh ones) produced was mounted on a FR car (2000 cc) made in Japan, the brake stopping distance required after the brake were applied at 100 km/h was measured on a wet asphalt road surface, and a friction coefficient μ was determined based on the measured value. The friction coefficient μ of Comparative Example 1 was regarded as 100, and the wet grip performance index of each example was calculated by the following formula. A larger wet grip performance index indicates better wet grip performance.

(Wet grip performance index)=(friction coefficient μ in each example)/(friction coefficient μ in Comparative Example 1)×100

### <Abrasion Resistance>

A set of test winter tires (fresh ones) (tire size: 195/65R¹⁵) produced was mounted on a FF car (2000 cc) made in Japan. The depth of grooves on the tire tread part was measured after the car had run 8000 km. The running distance that made the depth of the tire grooves decrease by 1 mm was calculated, and the result of each example was expressed with an abrasion resistance index by the following equation. A larger index indicates better abrasion resistance.

(Abrasion resistance index)=(running distance that made tire groove depth decrease by 1 mm in each example)/(running distance that made tire groove depth decrease by 1 mm in Comparative Example 1)×100

### <Blooming>

The produced vulcanized rubber composition was visually evaluated for bloom formation.

A: no bloom
B: a little bloom
C: much bloom

TABLE 1

| | | | | | | Com- | Com- | Com- | Com- | Com- | Com- | Com- |
|---|---|---|---|---|---|---|---|---|---|---|---|---|
| | | | | | | par- | par- | par- | par- | par- | par- | par- |
| | | | | | | ative | ative | ative | ative | ative | ative | ative |
| | | | Exam- | Exam- | Exam- | Exam- | Exam- | Exam- | Exam- | Exam- | Exam- | Exam- |
| | | | ple 1 | ple 2 | ple 3 | ple 1 | ple 2 | ple 3 | ple 4 | ple 5 | ple 6 | ple 7 |
| Formulation | Process 1 | NR | 60 | 60 | 60 | 60 | 60 | 60 | 60 | 60 | 60 | 60 |
| (part(s) by | | BR | 40 | 40 | 40 | 40 | 40 | 40 | 40 | 40 | 40 | 40 |
| mass) | | Carbon black | 5 | 5 | 20 | 20 | 5 | 5 | 5 | 5 | 5 | 20 |
| | | Silica | 60 | 60 | 30 | 30 | 60 | 60 | 60 | 60 | 60 | 30 |
| | | Silane coupling agent | 4.8 | 4.8 | 2.4 | 2.4 | 4.8 | 4.8 | 4.8 | 4.8 | 4.8 | 2.4 |
| | | Mineral oil | — | — | — | 20 | 60 | — | — | — | 60 | 25 |
| | | Aromatic oil | 60 | 60 | 25 | — | — | 60 | 60 | 60 | — | — |
| | | Stearic acid | 2 | 2 | 2 | 2 | 2 | 2 | 2 | 2 | 2 | 2 |
| | | Zinc oxide | 3 | 3 | 3 | 3 | 3 | 3 | 3 | 3 | 3 | 3 |
| | | Antioxidant | 2 | 2 | 2 | 2 | 2 | 2 | 2 | 2 | 2 | 2 |
| | | Wax | 2 | 2 | 2 | 2 | 2 | 2 | 2 | 2 | 2 | 2 |
| | Process 2 | Sulfur | 1.5 | 1.5 | 1.5 | 1.5 | 1.5 | 1.5 | 1.5 | 1.5 | 1.5 | 1.5 |
| | | Vulcanization accelerator | 1.5 | 1.5 | 1.5 | — | — | — | 1.5 | 1.5 | 1.5 | 1.5 |
| | | 4m-MBTS | | | | | | | | | | |
| | | Vulcanization accelerator | 0.5 | 1.0 | 1.0 | — | — | — | — | — | 1.0 | 1.0 |
| | | TMTM | | | | | | | | | | |
| | | Vulcanization accelerator | — | — | — | 1.5 | 1.5 | 1.5 | 1.5 | 1.5 | — | — |
| | | NS | | | | | | | | | | |
| | | Vulcanization accelerator | — | — | — | 1.0 | 2.0 | 2.0 | 1.0 | 2.0 | — | — |
| | | DPG | | | | | | | | | | |

| | | | | | | | | | | | |
|---|---|---|---|---|---|---|---|---|---|---|---|
| Evaluation | Hardness (−10° C.) | 50 | 50 | 50 | 50 | 50 | 52 | 52 | 52 | 50 | 50 |
| | Hardness after thermal degradation | 56 | 56 | 55 | 55 | 61 | 63 | 57 | 57 | 58 | 57 |
| | (−10° C.) | | | | | | | | | | |
| | Tg (° C.) | −58 | −58 | −60 | −60 | −65 | −58 | −58 | −58 | −58 | −60 |
| | Performance on snow and ice | 120 | 119 | 100 | 100 | 125 | 120 | 120 | 119 | 125 | 100 |
| | (fresh one) | | | | | | | | | | |
| | Performance on snow and ice | 116 | 115 | 112 | 100 | 82 | 90 | 115 | 114 | 90 | 105 |
| | (thermally-degraded one) | | | | | | | | | | |
| | Wet grip performance | 125 | 124 | 99 | 100 | 110 | 125 | 125 | 123 | 110 | 100 |
| | Abrasion resistance | 145 | 143 | 99 | 100 | 115 | 145 | 145 | 140 | 115 | 100 |
| | Blooming | A | A | A | A | A | A | A | A | A | A |
| | Curing time | 105 | 95 | 110 | 100 | 100 | 100 | 180 | 170 | 100 | 110 |
| | Torque rise value | 95 | 100 | 100 | 100 | 95 | 95 | 60 | 60 | 95 | 95 |

Table 1 shows that in Examples in which a rubber component containing an isoprene-based rubber and a butadiene rubber, a predetermined amount of silica, a predetermined amount of aromatic oil, a compound represented by the above formula (I) and/or formula (II) (4m-MBTS), and a thiuram vulcanization accelerator (TMTM) were used, good performance on snow and ice, wet grip performance, and abrasion resistance were achieved, and also the increase in hardness caused by thermal degradation and the reduction in performance on snow and ice caused by thermal degradation were suppressed. In addition, each torque rise value was not greatly reduced, and each curing time T₉₅ was not greatly increased. Particularly in Examples 1 and 2 in which 60 parts by mass of silica and 60 parts by mass of aromatic oil were used, the performance on snow and ice, wet grip performance, and abrasion resistance were very good.

In contrast, in Comparative Example 1 in which 20 parts by mass of mineral oil was used and 4m-MBTS and TMTM were not used, the increase in hardness caused by thermal degradation and the reduction in performance on snow and ice caused by thermal degradation were suppressed to a certain extent because the oil amount was small; however, the performances were greatly inferior to those in Examples. In Comparative Example 2 in which the amounts of silica and mineral oil were larger than those of Comparative Example 1, the performances including the performance on snow and ice were improved compared to Comparative Example 1, but an increase in hardness caused by thermal degradation and a reduction in performance on snow and ice caused by thermal degradation were large. Also in Comparative Example 3 in which the formulation was the same as that of Comparative Example 2, except that aromatic oil was used instead of mineral oil, an increase in hardness caused by thermal degradation and a reduction in performance on snow and ice caused by thermal degradation were large. In Comparative Examples 4 and 5 in which 4m-MBTS was added as compared to Comparative Example 3, the increase in hardness caused by thermal degradation and the reduction in performance on snow and ice caused by thermal degradation were suppressed, but the torque rise value was smaller (cross-linking efficiency was lower) and the curing time T₉₅ was larger compared to those of Examples. In Comparative Example 6 in which the formulation was the same as that of Example 2, except that mineral oil was used instead of aromatic oil, the effects of suppressing an increase in hardness caused by thermal degradation and a reduction in performance on snow and ice caused by thermal degradation, the wet grip performance, and the abrasion resistance were smaller and the curing time T₉₅ was larger, compared to those of Example 2. Also in Comparative Example 7 in which the formulation was the same as that of Example 3, except that mineral oil was used instead of aromatic oil, the effects of suppressing an increase in hardness caused by thermal degradation and a reduction in performance on snow and ice caused by thermal degradation were smaller than those of Example 3.

1. A rubber composition for a cap tread, comprising:
a rubber component containing an isoprene-based rubber and a butadiene rubber;
silica;
aromatic oil;
a compound represented by the following formula (I) and/or formula (II); and
a thiuram vulcanization accelerator,
wherein the amount of the silica is 15 to 80 parts by mass, and the amount of the aromatic oil is 15 to 80 parts by mass, per 100 parts by mass of the rubber component: 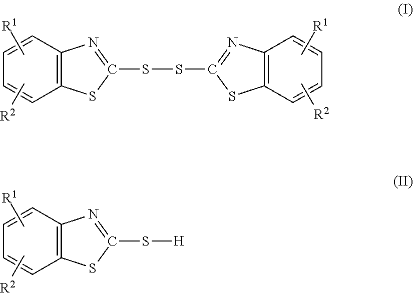
wherein R¹ and R² may be the same as or different from each other, and each represent a hydrogen atom, an alkyl group, an aryl group, or an aralkyl group, provided that the case where R¹ and R² are simultaneously hydrogen atoms is excluded.

2. The rubber composition for a cap tread according to claim 1,
wherein the amount of the silica is 40 to 80 parts by mass, and the amount of the aromatic oil is 35 to 80 parts by mass, per 100 parts by mass of the rubber component.

3. The rubber composition for a cap tread according to claim 1,
wherein the amount of the thiuram vulcanization accelerator is 0.1 to 1.2 parts by mass per 100 parts by mass of the rubber component.

4. The rubber composition for a cap tread according to claim 1,
wherein the isoprene-based rubber is at least one selected from the group consisting of an isoprene rubber, a natural rubber, and a modified natural rubber.

5. The rubber composition for a cap tread according to claim 1,
wherein the compound is represented by the following formula (III).

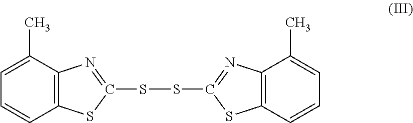

6. The rubber composition for a cap tread according to claim 1,
wherein the total amount of the isoprene-based rubber and the butadiene rubber in 100% by mass of the rubber component is 30 to 100% by mass.

7. The rubber composition for a cap tread according to claim 1,
wherein the amount of the silica in 100% by mass of a total of the silica and carbon black is 50% by mass or more.

8. A winter tire, comprising: a cap tread produced from the rubber composition according to claim 1.
